(19) United States
(12) Patent Application Publication
(10) Pub. No.: US 2026/0181429 A1
(43) Pub. Date: Jun. 25, 2026

(54) METHODS FOR AI/ML CHANNEL STATE INFORMATION USING SPARSE REFERENCE SIGNALS

(71) Applicant: InterDigital Patent Holdings, Inc., Wilmington, DE (US)

(72) Inventors: Anouar Yatribi, Greater London (GB); Mihaela Beluri, Jericho, NY (US); Ahmet Serdar Tan, London (GB); Patrick Tooher, Montreal (CA); Moon IL Lee, Melville, NY (US); Dylan Watts, Montreal (CA)

(73) Assignee: InterDigital Patent Holdings, Inc., Wilmington, DE (US)

(21) Appl. No.: 18/989,524

(22) Filed: Dec. 20, 2024

(51) Int. Cl. H04W 24/08; H04L 5/00; H04W 24/10

(52) U.S. Cl. CPC H04W 24/08; H04L 5/0048; H04W 24/10

(57) ABSTRACT

A wireless transmit/receive unit (WTRU) may receive configuration information. The configuration information may comprise one or more performance thresholds for prediction model monitoring. The WTRU may perform one or more measurements. The WTRU may determine that a triggering condition is satisfied when the one or more measurements meet the one or more performance thresholds. The WTRU may send an indication comprising a request that evaluation channel state information (CSI)-reference signals (RSs) be transmitted within a monitoring window. The WTRU may receive the evaluation CSI-RSs within the monitoring window. The WTRU may select a CSI reporting method based on measurements associated with the evaluation CSI-RSs. The WTRU may determine a CSI report based on the CSI reporting method. The WTRU may send one or more of the CSI report, the CSI reporting method, and/or a type of measurement used to select the evaluation CSI-RSs.

### BACKGROUND

Artificial intelligence and machine learning (AI/ML) based channel state information (CSI) prediction was studied in Rel-18 and/or Rel-19 as means to both mitigate channel aging and reduce the CSI feedback overhead. AI/ML based CSI prediction may use one-sided AI/ML models residing at the wireless transmit/receive unit (WTRU)-side, thus CSI prediction is performed by the WTRU.

Additionally, new radio (NR) Rel-18 specified enhancements to the multiple-input multiple-output (MIMO) codebook (enhanced Type II codebook for predicted precoding matrix indicator (PMI)) to handle high Doppler scenarios. The work may enable predicted PMIs for N4=1,2,4,8 future instances (e.g., where the prediction may be achieved using non-AI/ML based approaches).

CSI prediction (whether AI/ML or non-AI/ML based) relies on historical CSI instances (channel estimates based on the received CSI-RS) in an observation window to predict one or more future CSI instances. The Rel-18 and/or Rel-19 studies used a short period for the CSI-RS configuration (e.g., 5 ms CSI-RS periodicity) to enable accurate CSI prediction. However, while a short period for CSI-RS may be needed for accurate prediction, it creates unwanted interference to the data channels in the adjacent cells. Unwanted interference may degrade the overall system performance. For this reason, practical field deployments use longer CSI-RS periodicity (e.g., 20 ms), which may reduce the adjacent cell interference. However, a longer CSI-RS period may degrade the CSI prediction performance, such as when a WTRU moves at higher speeds.

### SUMMARY

A wireless transmit/receive unit (WTRU) may receive configuration information. The configuration information may comprise one or more performance thresholds for prediction model monitoring. The WTRU may perform one or more measurements. The types of measurements to be performed may comprise at least prediction error metrics and/or channel measurements. The WTRU may determine that a triggering condition is satisfied when the one or more measurements meet the one or more performance thresholds. The WTRU may send an indication comprising a request that evaluation channel state information (CSI)-reference signals (RSs) be transmitted within a monitoring window. The WTRU may receive the evaluation CSI-RSs within the monitoring window. The WTRU may select a CSI reporting method based on measurements associated with the evaluation CSI-RSs. The WTRU may determine a CSI report based on the CSI reporting method. The WTRU may send one or more of the CSI report, the CSI reporting method, and/or a type of measurement used to select the evaluation CSI-RSs.

The WTRU may measure the evaluation CSI-RSs, and/or determine, based on the measurements associated with the evaluation CSI-RSs, to fallback to a non-artificial intelligence or a machine learning (AI/ML) predictive CSI reporting when the measured evaluation CSI-RS measurements indicate an AI/ML model issue.

The WTRU may measure the evaluation CSI-RSs, and/or determine, based on the measurements associated with the evaluation CSI-RSs, to fallback to non-predictive CSI reporting for a configured time window when an interference measured on the received evaluation CSI-RS is above a second threshold.

The WTRU may measure the evaluation CSI-RSs and/or determine, based on the measurements associated with the evaluation CSI-RSs, to fallback to a closest historical CSI when the evaluation CSI-RS measurements indicate that the configuration information is not applicable to the channel conditions.

The WTRU may perform an AI/ML model operation for AI/ML predictive CSI reporting when the WTRU configuration information further comprises an aperiodic CSI-RS for prediction.

The measurements associated with prediction error metrics may comprise one or more of a normalized mean square error, (NMSE), a squared generalized cosine similarity (SGCS), or a mean absolute difference. The measurements associated with channel measurements may comprise one or more of a Doppler spread, a channel coherence time, or a time-domain channel property (TDCP).

The request for evaluation CSI-RS comprises an indication of a number of evaluation CSI-RSs in time domain. The duration of the monitoring window is pre-configured by the WTRU, configured by a network, and/or requested by the WTRU and confirmed by the network. The CSI report may comprise one or more of a reason for CSI prediction performance degradation, the CSI reporting method, and/or values of the measurements that met the performance threshold.

### BRIEF DESCRIPTION OF THE DRAWINGS

FIG. 1A is a system diagram illustrating an example communications system in which one or more disclosed embodiments may be implemented.

FIG. 1 B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

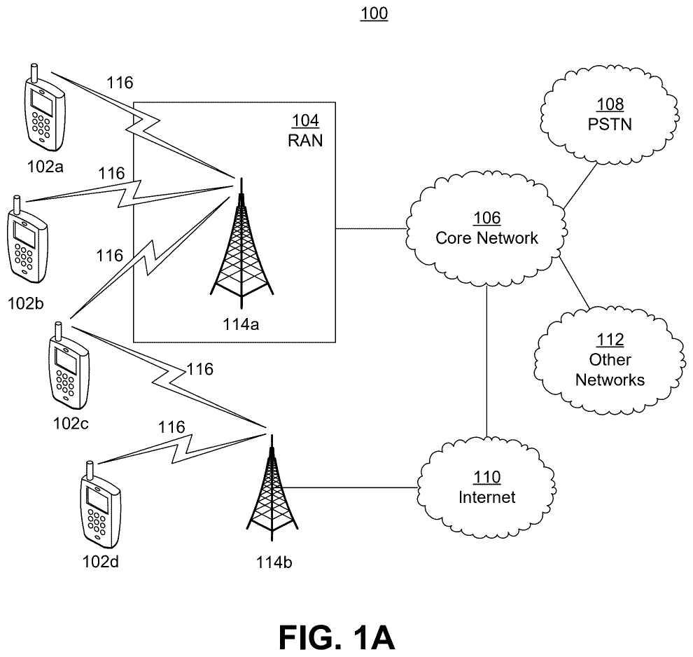

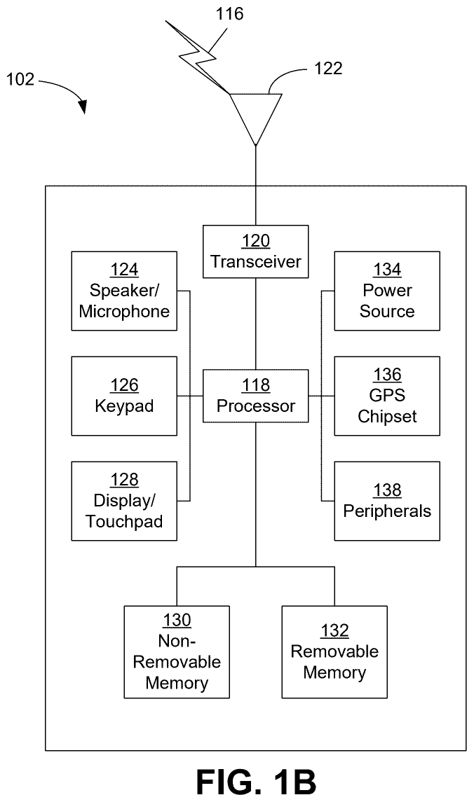

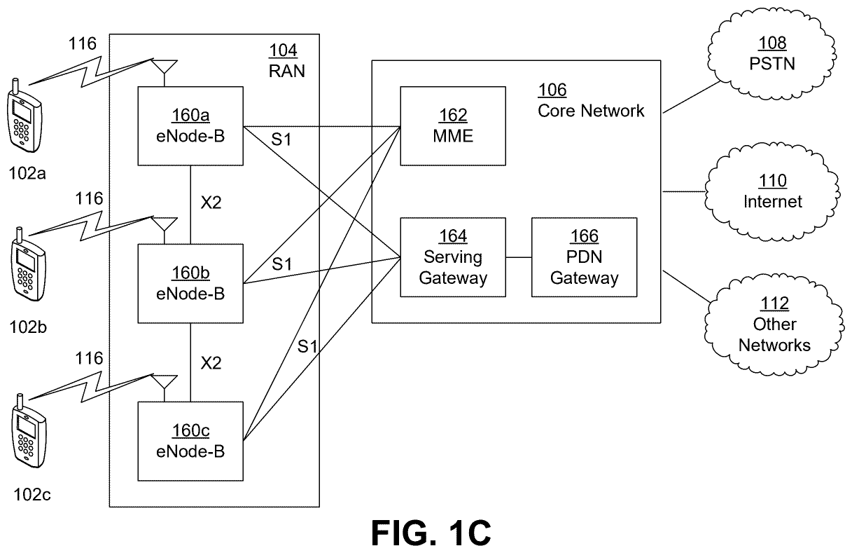

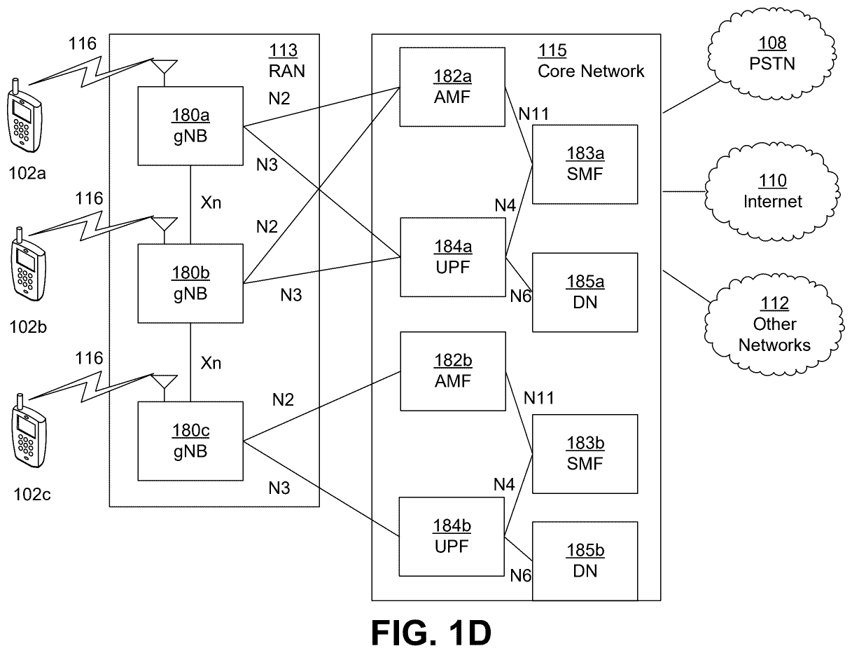

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1 B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11 e DLS or an 802.11 z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11 af and 802.11 ah. The channel operating bandwidths, and carriers, are reduced in 802.11af and 802.11 ah relative to those used in 802.11 n, and 802.11ac. 802.11af supports 5 MHz, 10 MHz and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11 n, 802.11 ac, 802.11 af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11 ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11 ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A potential solution is to use aperiodic (AP) channel state information (CSI)-reference signal (RS) in conjunction with longer CSI-RS periods. This may improve the prediction performance and/or reduce the inter-cell interference compared to the shorter (e.g., 5 ms) CSI-RS configuration.

However, excessive use of AP CSI-RS to improve the prediction performance of wireless transmit/receive units (WTRUs), also known as user equipment (UE), in a given cell may still create interference to adjacent cells. Identifying the reason for CSI prediction performance degradation and/or taking the WTRU action based on the determined reason for degradation is an important step in enabling high quality system performance.

For systems using CSI prediction with a temporally sparse CSI-RS configuration, the following problems are addressed: how to identify the reason for CSI prediction performance degradation; and/or what actions does the WTRU take to mitigate the prediction performance degradation while limiting the number of AP CSI-RS used for prediction (e.g., in addition to the configured temporally sparse periodic CSI-RS).

A WTRU may perform artificial intelligence and/or machine learning (AI/ML) channel state information (CSI) prediction using temporally sparse CSI-reference signal (RS) configuration may send a request for evaluation CSI-RS within a monitoring window. The WTRU may then determine the reason for CSI prediction performance degradation. The WTRU may select the behavior and/or action as a function of determined reason for performance degradation.

A WTRU capable of AI/ML CSI prediction may receive a configuration for prediction and/or model monitoring. The configuration may include: a CSI-RS configuration and/or performance thresholds for prediction model monitoring. The WTRU may perform measurements for model performance monitoring. The measurements may include prediction error metrics such as normalized mean square error (NMSE) and/or squared generalized cosine similarity (SGCS). The measurements may include channel measurements such as Doppler, channel coherence time, and/or time domain channel property (TDCP).

The WTRU may evaluate trigger conditions. The trigger conditions may be satisfied when the measured prediction error meets the configured threshold. The trigger conditions may be satisfied when the measured channel has high Doppler (e.g., low coherence time). When the trigger conditions are met, the WTRU may send an indication to the network (NW). The indication may include a request for evaluation CSI-RS within a monitoring window, a report of the measurement value(s), and/or type(s) of measurements that met the trigger (e.g., channel coherence time and/or TDCP, etc.). The request for evaluation CSI-RS may include the number of evaluation CSI-RS in time domain. The monitoring window may be pre-defined, NW-configured, and/or the WTRU may send a request for specific window length.

The WTRU may select a CSI reporting method based on whether it receives evaluation CSI-RS within a monitoring window, and (if possible) measurements performed on the evaluation CSI-RS. If the WTRU does not receive evaluation CSI-RS within the monitoring window, then the WTRU may fall back to non-predictive CSI reporting and/or non-AI/ML predictive CSI reporting based on the model performance monitoring measurements. If the WTRU does receive evaluation CSI-RS within the monitoring window, then the WTRU may perform measurements on the evaluation CSI-RS. In addition to performing the measurement, the WTRU may determine to fallback to non-AI/ML predictive CSI reporting if the evaluation CSI-RS measurements indicate an AI/ML model issue. In addition to performing the measurement, the WTRU may determine to fallback to non-predictive CSI reporting for a configured time window if the interference measured on the evaluation CSI-RS is above a threshold. In addition to performing the measurement, the WTRU may determine to fall back to the closest historical CSI if the evaluation CSI-RS measurements indicate that the CSI-RS configuration is mismatched to the channel conditions (e.g., the channel decorrelates within the configured CSI-RS period). In addition to performing the measurement, the WTRU may determine to continue using the AI/ML model for AI/ML predictive CSI reporting when the WTRU receives configuration for aperiodic CSI-RS for prediction, e.g., if the evaluation CSI-RS measurements indicate that the CSI-RS configuration is mismatched to channel conditions (e.g., in time and/or frequency domain).

The WTRU may compute the CSI report using the selected CSI measurement report method. The WTRU may transmit one or more of: the computed CSI report, the selected CSI measurement report method, and/or the measurement used to select the CSI measurement report method.

By determining the reason for CSI prediction performance degradation and/or selecting the WTRU behavior as a function of the determined reason, the need to schedule aperiodic (AP) CSI-RS for CSI prediction in the current cell is reduced. This reduces the interference to the adjacent cell and/or improves the overall system performance.

As used herein, the term “evaluation CSI-RS” may refer to the CSI-RS received during the monitoring window, which may be periodic, aperiodic, and/or semi-persistent.

As used herein, the term “non-predictive CSI reporting” may refer to a method to determine the reported CSI as a function of one or more historical CSI values within a time interval. The function may be, e.g., an average of the historical CSI values within the time interval and/or the closest (e.g., latest) historical CSI.

A WTRU equipped with an AI/ML model capable of performing AI/ML based CSI prediction may receive a CSI-RS configuration to perform CSI measurements. The configuration for CSI-RS may be periodic, aperiodic, and/or semi-persistent. The WTRU may receive: a configuration for the AI/ML CSI prediction model; a configuration for the model performance monitoring, including measurement(s) and/or trigger(s) configuration; and/or a configuration for WTRU actions when trigger conditions are met. The WTRU may also receive configuration for CSI feedback, which may be periodic, aperiodic, and/or semi-persistent.

The configuration of the AI/ML CSI prediction model may include at least one or more of the following: configuration the prediction window. This may include the number of predicted CSI instances in the prediction window, N₄, and the period (e.g., time) between consecutive predicted CSI instances, d.

The configuration of the AI/ML CSI prediction model may include a configuration of the observation window. The observation window configuration may include the number of historical CSI samples K, in the observation window and the period (e.g., time) between consecutive CSI in the observation window, m. The number of historical CSI samples K, in the observation window may be equal to or less than the configured ML prediction model capability.

The configuration of the AI/ML CSI prediction model may include thresholds for error detection. These may include TDCP threshold and/or prediction error threshold (corresponding to the configured performance metrics, e.g., SCGS, NMSE, etc.)

The configuration of the AI/ML CSI prediction model may include a CSI prediction model information and/or specifications. For example, when the model was transferred to the WTRU (e.g., from the NW), the CSI prediction model information may include model capability information, maximum number of instances in the prediction window, maximum buffer size for the observation window, and/or CSI-RS periodicity. The configuration may also include information on the dataset used for model training, such as: minimum and/or maximum WTRU speed, statistical properties of the channel (e.g., coherence bandwidth (BW) of the channel, and/or line of sight/no line of sight (LOS/NLOS) properties). Additionally, the configuration may include the domain for the CSI historical samples at the prediction model input (e.g., raw channel and/or eigenvectors).

The configuration for model performance monitoring may include at least one or more of the following: performance metrics. Performance metrics may be intermediate key performance indicators (KPI) such as one or more of the following metrics: mean square error (MSE), NMSE, SGCS. Performance metrics can be system throughput, and/or ACK/NACK rate, and/or block error rate (BLER).

The configuration for model performance monitoring may include input distribution metrics. For example, a WTRU may be configured with one or more statistical metric(s) to detect the distribution shift of input CSI samples with respect to training dataset. A WTRU may be configured to detect out of distribution (OOD) samples via different metrics, such as a OOD detection algorithm/method/classifier (e.g., AI/ML or non-AI/ML based), probability density function (PDF), cumulative density function (CDF), outliers rate, and/or first-order statistics.

The configuration for model performance monitoring may include performance thresholds for AI/ML prediction. For example, a WTRU may be configured with one or more threshold(s) associated to each performance monitoring metric.

The configuration for model performance monitoring may include performance monitoring granularity in the monitoring window. For example, WTRU may be configured with granular parameters with respect to the duration of the monitoring window. Performance metrics may be calculated across the duration of the monitoring window, averaged across a specific time-interval of the monitoring window, and/or averaged across the number of observation windows during monitoring window.

The WTRU may be configured with a performance monitoring window. For example, the configuration thereof may include one or more of the following: monitoring window duration. For example, the duration of the monitoring window may be determined as a function of the observation window duration and the CSI-RS periodicity. The monitoring window duration may be configured based on how many predictions occasions WTRU determines, and/or with respect to the CSI-RS period and the observation window size.

The configuration for performance monitoring window may include monitoring window timing. For example, the WTRU may receive an indication (e.g., flag) of the activation of the monitoring window in a pre-defined and/or pre-configured time duration after sending a request for evaluation CSI-RS. The WTRU may determine the start of the monitoring window at the first periodic and/or sparse CSI-RS received after the request for evaluation CSI-RS. The WTRU may determine semi-persistent and/or aperiodic time-intervals with durations equal to the observation window.

The configuration for WTRU measurements may include measurement metrics, in addition to thresholds and/or ranges associated to each measurement metric. The configuration for measurements may include at least one or more of the following: channel measurements. For example, channel measurements may include Doppler, channel coherence time, TDCP (wherein TDCP configuration may include one or more configured delays), and/or a correlation of samples within an observation window.

The configuration for WTRU measurements may include applicable conditions. For example, applicable conditions may include WTRU speed, reference signal received power (RSRP), signal to interference ratio (SINR), WTRU location and/or WTRU relative position with respect to the serving cell.

A WTRU may also be configured with a set of thresholds and/or ranges associated to each measurement. This configuration may include one or more of the following: threshold for Doppler spread; threshold for channel coherence time; a threshold for TDCP; and/or a threshold relative to the position, location, and/or distance of the WTRU with respect to the serving cell.

The WTRU may be configured with a threshold for correlation of samples within the observation window; threshold and/or range for WTRU speed. Based on the AI/ML CSI prediction model, a threshold or range of WTRU speed where the model performs well without performance degradation may exist.

The WTRU may be configured with a threshold or range for RSRP. For example, depending on the channel conditions of the links used for training the AI/ML model, wherein prediction performance may be degraded if the channel condition (RSRP) is below a threshold.

The WTRU may be configured with a threshold for SINR. For example, the SINR may indicate that the WTRU is at the cell-edge, and/or undergoing interferences caused by different factors. High interferences may impact the prediction performance, and/or the AI/ML model may suffer from performance degradation if the SINR is above a certain threshold.

A WTRU may be configured with one or more trigger conditions for requesting the evaluation CSI-RS. The trigger conditions may be defined based on different combinations of whether a set of measurements meet their associated thresholds and/or ranges.

The configuration for WTRU trigger conditions may include at least one or more of the following conditions: the measured prediction error meets a configured threshold (e.g., one or more metric(s)), and the measured channel has high Doppler above a configured threshold, and/or the measured channel has low coherence time below a configured threshold; the measured prediction error meets a configured threshold (e.g., one or more metric(s)), and WTRU speed is above a threshold/range; the measured prediction error meets a configured threshold (e.g., one or more metric(s)), and/or WTRU speed is above a threshold/range, and TDCP is below a configured threshold (e.g., fast time-varying channel); the measured prediction error meets the configured threshold, and SINR is above a configured threshold, and/or WTRU relative location is below a configured distance/radius from the serving cell (e.g., WTRU is relatively close to the cell-center); and/or the RSRP measured from the received CSI-RS is below a configured threshold, and/or the correlation of collected samples within the observation window is below a threshold.

The WTRU may be configured with any one or more combinations of these trigger conditions. If one or more of the conditions are met, then the WTRU may request (e.g., be triggered to request) the evaluation CSI-RS.

A WTRU may be configured with a set or subset of CSI reporting methods based on trigger conditions. The WTRU may determine the reporting method via measurements on periodic CSI-RS (e.g., measurements used for trigger conditions) and/or evaluation CSI-RS (e.g., measurement on evaluation CSI-RS). Alternatively, the WTRU may be (pre-)configured with one or more subsets of actions that depend on whether specific trigger conditions and evaluation CSI-RS measurements are met. For example, the WTRU may be configured via RRC signaling with one or more mapping table(s) that associate each set and/or subset of trigger conditions and/or measurements on evaluation and/or periodic CSI-RS to one or more subsets of actions to perform (e.g., the determined reporting method). The WTRU may receive a dynamic configuration thereof via MAC-CE, such as after the monitoring window duration expiry.

The configuration for WTRU reporting may include one or more of the following: content of CSI feedback report. For example, the WTRU may report one or more of the following: determined reason for CSI prediction performance degradation; selected CSI reporting method; value(s) of the metrics that met trigger conditions; AI/ML model performance measurement values; values of measurements performed on the evaluation CSI-RS; and/or CSI computed with the selected CSI reporting method.

The configuration for WTRU reporting may further include signaling of CSI report feedback. For example, WTRU may be configured with a first report, second report, and/or a joint report. The configuration for WTRU reporting may include periodicity of the CSI feedback report. For example, a WTRU may be configured for periodic, aperiodic, and/or semi-persistent CSI feedback report.

A WTRU configured with CSI prediction may perform measurements for the monitoring of CSI prediction model. The measurements performed may include one or more of the following: prediction error. The WTRU may measure the prediction error of the CSI predictions by comparing the predictions to actual measured CSI. The WTRU may compute prediction error metrics, such as squared generalized cosine similarity (SGCS), normalized mean square error (NMSE) or mean absolute difference.

SGCS may be calculated as

$${m}_{1} ∼ {( \frac{‖ {h}_{k}^{H} {h}_{k}^{′} ‖}{‖ {h}_{k} ‖ ‖ {h}_{k}^{′} ‖} )}^{2}$$

where hₖ and

$${h}_{k}^{′}$$

represents the measured CSI and predicted CSI, respectively, for k-th subband. NMSE may be calculated as

$${m}_{2} ∼ \frac{{‖ {h}_{k} - {h}_{k}^{′} ‖}^{2}}{{‖ {h}_{k} ‖}^{2}}$$

The mean absolute difference may be calculated as m₃˜∥hₖ−h′ₖ∥₁

The measurements performed may include channel measurements. The WTRU may perform measurements related channel properties. The measurements may include one or more of the following: Doppler spread, which measures the frequency shifts in the radio signal due to relative motion between WTRU and NW; channel coherence time, which measures the time interval during which the channel's characteristics remain relatively constant; TDCP, which measures wideband normalized correlation between two reference signals; and/or correlation of channel samples within the observation window.

The measurements performed may include applicable conditions. The WTRU may perform measurements on applicable conditions including one or more of the following: WTRU speed measurement which impacts channel correlation and/or Doppler spread; RSRP which measures the received signal strength in the reference signals received; signal to interference ratio (SINR) which measures the ratio of the received signal strength of reference signals to the interference strength; and/or WTRU location measurement which impacts the received power and interference.

The WTRU may evaluate the trigger conditions for requesting evaluation CSI-RS based on one or more of the following: prediction error. The WTRU may evaluate the prediction error, e.g., by comparing the prediction error to a threshold. If the prediction error is above a threshold, then the WTRU may be triggered to request evaluation CSI-RS from the NW. The NW may configure the measurement threshold.

The WTRU may evaluate the trigger conditions for requesting evaluation CSI-RS based on channel measurements. If one or more of the following conditions are met, then the WTRU may be triggered to request evaluation CSI-RS from the NW: Doppler spread (e.g., if the Doppler spread is above a configured threshold); channel coherence time (e.g., if the channel coherence time is below a configured threshold); TDCP (e.g., if the measured TDCP values is below a configured threshold); and/or correlation of channel samples (e.g., if the correlation of channel samples is below a configured threshold).

The WTRU may evaluate the trigger conditions for requesting evaluation CSI-RS based on applicable conditions. If one or more of the following applicable conditions are met, then the WTRU may be triggered to request evaluation CSI-RS from the NW: WTRU speed (e.g., if the WTRU speed is above a configured threshold); RSRP (e.g., if the measured RSRP is below a configured threshold); SINR (e.g., if the measured SINR is above a configured threshold); and/or WTRU location (e.g., if the WTRU location is near the cell edge).

The WTRU may be triggered to request evaluation CSI-RS if any of the above conditions are met. The WTRU may be triggered to request evaluation CSI-RS if a combination of the above conditions is met: if the prediction error is above a threshold, and doppler spread is above a threshold. This condition may occur with low coherence time. This combination of conditions may ensure that the WTRU is triggered with low coherence time only if the prediction error is high.

The WTRU may be triggered to request evaluation CSI-RS if the prediction error is above a threshold and WTRU speed is above a threshold and/or range, and TDCP is below a configured threshold. This condition may occur with fast time-varying channel. This combination of conditions may ensure that the WTRU is triggered only with fast time varying channel only if the prediction error is high.

The WTRU may be triggered to request evaluation CSI-RS if the prediction error is above a threshold, and SINR is above a configured threshold, and WTRU distance to gNB is above a threshold. This condition may occur when the WTRU is has low spectral efficiency at cell edge. This combination of conditions may ensure that the WTRU is triggered with cell edge conditions only if the prediction error is high.

The WTRU may be triggered to request an evaluation CSI-RS within a configured monitoring window. The WTRU may be triggered when the trigger conditions are met. The WTRU may include in the request only the evaluation CSI-RS. In such case, the indication may be transmitted via uplink control information (UCI) (e.g., a new reserved UCI field).

The WTRU may include in the indication the request for the evaluation CSI-RS. The WTRU may further include a report of one or more measurements values and/or types, based on the met trigger condition(s), such as coherence time, prediction performance, TDCP, and/or channel conditions, etc. In this solution, the WTRU may transmit the request for evaluation CSI-RS via MAC-CE.

The WTRU may include in the request for evaluation CSI-RS the number of evaluation CSI-RS instances in time-domain. The WTRU may include more granularity details about the evaluation CSI-RS, such as the time offset between each evaluation CSI-RS. The evaluation CSI-RS may be periodic within a time interval, aperiodic, and/or semi-persistent.

If the monitoring window is not pre-defined and/or NW-configured, then the WTRU may include in the indication a request for a specific monitoring window length. The request of a specific monitoring window may include details such as: monitoring window duration. For example, the WTRU may determine and/or indicate in the request the window duration as a function of the coherence time, the correlation measurements, WTRU speed, and/or the observation window (e.g., time to collect a sufficient number of evaluation CSI-RS samples in the observation window). The window duration may be in function of the periodic CSI-RS and the observation window, and/or as a function of the number of prediction and/or reporting occasions where performance is monitored and the observation window.

The request of a specific monitoring window may include monitoring window timing. For example, the WTRU may receive an indication (e.g., flag) of the activation of the monitoring window in a pre-defined and/or pre-configured time duration after sending a request for evaluation CSI-RS. The WTRU may determine the start of the monitoring window at the first configured CSI-RS received after the request for evaluation CSI-RS. The WTRU may determine semi-persistent and/or aperiodic time-intervals with durations equal to the observation window.

The WTRU may receive the evaluation CSI-RS according to the monitoring window configuration. The WTRU may identify the evaluation CSI-RS via a new binary field in DCI, indicating whether the received CSI-RS is an aperiodic CSI-RS or an evaluation CSI-RS. The WTRU may determine that the received CSI-RS is evaluation CSI-RS when WTRU receives a first CSI-RS within the monitoring window. The WTRU may not be configured with aperiodic and/or activated semi-persistent CSI-RS. The WTRU can receive an indication or flag as a confirmation that the next CSI-RS is an evaluation CSI-RS.

The WTRU may select a CSI reporting method based on whether it receives an evaluation CSI-RS within a configured, determined, and/or indicated monitoring window. The WTRU may determine that the evaluation CSI-RS is not received, in function of the monitoring window timing. In this solution, the WTRU may perform a fallback to non-predictive CSI reporting based on performance monitoring measurements (e.g., if one or more configured monitoring metric(s) are below a second configured monitoring threshold).

If the WTRU does receive evaluation CSI-RS within the monitoring window, then the WTRU may perform measurements, and/or determine a CSI reporting method as a function of the trigger measurements and/or the measurements on the evaluation CSI-RS.

The measurements on the evaluation CSI-RS may include one or more of the following: one or more prediction monitoring measurements, in function of the monitoring window, based on one or more metric(s), such as MSE, NMSE, and/or SGCS. For example, the WTRU may perform AI/ML based prediction in occasions based on the monitoring window duration. The WTRU may then calculate the configured performance metrics based on the predicted outputs and/or the ground-truths.

The measurements on the evaluation CSI-RS may include OOD detection and/or statistical measurements. For example, the WTRU may process the input samples within one or more observation windows according to the monitoring window configuration. The WTRU may determine the OOD rate and/or score with respect to the training dataset information. The WTRU may calculate different statistical metrics, e.g., first-order statistics, correlation, PDF, and/or CDF, etc.

The measurements on the evaluation CSI-RS may include one or more measurements and/or applicable conditions, e.g., speed, coherence time, TDCP, Doppler, channel conditions (e.g., RSRP and/or SINR).

The WTRU may determine the CSI reporting method as a function of the performance measurements on the evaluation CSI-RS during the monitoring window and/or other measurements performed on trigger conditions (e.g., performed on the CSI-RS for the determination of trigger conditions). The CSI reporting method may be one of the following: fall back to non-AI/ML predictive CSI reporting. For example, the WTRU may fall back to non-AI/ML predictive reporting (e.g., Kalman and/or autoregressive (AR) based) if the evaluation CSI-RS measurements indicate an AI/ML model issue. In an example, AI/ML model issue may be detected based on input distribution drift on the evaluation CSI-RS, with respect to the AI/ML model specs/information (e.g., with respect to training dataset distribution). A model issue may be detected based on a OOD detection method/algorithm. An AI/ML model issue may be detected based on the input samples statistical metrics (e.g., one or more statistical metric) on many occasions (e.g., in function of the monitoring window interval). Another example of AI/ML model issue may be related to generalization and/or scalability.

The CSI reporting method may also fall back to non-predictive CSI reporting. For example, a WTRU may fall back to non-predictive CSI reporting for a configured time window if the interference measured on the evaluation CSI-RS is above a threshold. In this case, in an option, the WTRU may compare the measured interference (e.g., SINR) on the evaluation CSI-RS with the measured interference from the configured periodic CSI-RS (if among the trigger conditions). If the difference is below a threshold, then WTRU may fall back to non-predictive CSI reporting. The WTRU may fall back to non-predictive CSI reporting if the WTRU determines that the WTRU is located near cell-edge (e.g., based on the distance to the cell center). The WTRU may avoid additional evaluation CSI-RS which may create interference to the adjacent cell (thus potentially degrading the system performance).

The CSI reporting method may also fall back to the closest historical CSI. For example, the WTRU may fall back to the closest historical CSI if the evaluation CSI-RS measurements indicate that the CSI-RS configuration is mismatched to the channel conditions. For example, if the channel decorrelates within the configured CSI-RS period, and if the measured coherence time from the evaluation CSI-RS is below the observation window formed from samples based on the evaluation CSI-RS. Another example is if TDCP value(s) measured using the evaluation CSI-RS within the monitoring window is below a configured threshold.

The CSI reporting method may also regard whether the WTRU may determine to continue using the AI/ML model for AI/ML predictive CSI reporting when it receives configuration for aperiodic CSI-RS for prediction, (e.g., if the evaluation CSI-RS measurements indicate that the CSI-RS configuration is mismatched to channel conditions (e.g., in time and/or frequency domain).

The WTRU may determine the mismatch of the periodic CSI-RS with channel conditions based on the evaluation CSI-RS, based on one or more of the following options: if the prediction error of the evaluation CSI-RS is better than that of the configured CSI-RS. For example, the difference of average prediction performance across prediction occasions between the evaluation CSI-RS and the configured (e.g., periodic) CSI-RS may be above a configured threshold. Prediction performance metrics may be determined as a function of the performance monitoring configuration.

The WTRU may determine the mismatch of the periodic CSI-RS with channel conditions based on the evaluation CSI-RS if the correlation difference between observation windows from the evaluation CSI-RS and the periodic CSI-RS is above a configured threshold. For example, in function of the monitoring occasions (e.g., based on the monitoring window config), WTRU may determine the difference of averaged correlation across the observation windows. The WTRU may restrict to use a subset of recent observation windows.

The WTRU may determine the mismatch of the periodic CSI-RS with channel conditions based on the evaluation CSI-RS if the average coherence time measured from observation windows associated to the evaluation CSI-RS is above a threshold. For example, the threshold may be determined based on the evaluation CSI-RS configuration (e.g., periodicity).

The WTRU may determine the mismatch of the periodic CSI-RS with channel conditions based on the evaluation CSI-RS if the difference of the average TDCP and/or Doppler across the number of predicting occasions between the evaluation CSI-RS and the periodic CSI-RS is above or below a configured threshold.

The WTRU may determine the mismatch of the periodic CSI-RS with channel conditions based on the evaluation CSI-RS if WTRU distance or radius from the cell-center is below a configured threshold, and the average RSRP measured on the evaluation CSI-RS is above a configured threshold. For example, a distance below the threshold may indicate that interferences from adjacent cells PDSCH may have a low impact on prediction performance.

The WTRU may determine the mismatch of the periodic CSI-RS with channel conditions based on the evaluation CSI-RS if interference difference between evaluation CSI-RS and periodic CSI-RS is below a threshold. For example, WTRU may compare the average SINR across a configured interval of time and across all or a subset of samples, or relatively to the monitoring window duration, or relatively to the periodic CSI-RS.

The WTRU may determine the mismatch of the periodic CSI-RS with channel conditions based on the evaluation CSI-RS if the WTRU determines that the measured channel coherence bandwidth is smaller than the frequency domain spacing of the CSI-RS.

A WTRU monitoring the CSI prediction model may report the determined reason for CSI prediction performance degradation (e.g., to mitigate the degradation). The report may additionally include the selected CSI reporting method, performance monitoring metrics, and/or the computed CSI.

The WTRU feedback report may include one or more of the following: determined reason for CSI prediction performance degradation. The reason for CSI prediction performance degradation may be: the AI/ML model: e.g., when the data distribution at inference does not match the distribution of the training data; CSI-RS configuration mismatch: the CSI-RS configuration may be mismatched to the channel conditions, e.g., when the coherence time of the channel is shorter than the CSI-RS periodicity. In this case, the historical CSI samples in the observation window for the CSI prediction model become decorrelated, which may lead to prediction performance degradation. Interference may be a reason for CSI prediction performance degradation: for example, when the measured interference exceeds a configured threshold.

The WTRU feedback report may include selected CSI reporting method, where the selected CSI reporting method may be any of the following: AI/ML predictive CSI (e.g., where the prediction function is achieved using AI/ML models); non-AI/ML predictive CSI (e.g., where the prediction function is achieved using Kalman filters or auto-regressive (AR) filters); and/or non-predictive CSI and/or the closest historical CSI.

The WTRU feedback report may include: value(s) of metrics that met the trigger conditions: for example, the reported metrics values may be channel measurements such as Doppler, channel coherence time, and/or TDCP.

The WTRU feedback report may include: model performance monitoring measurement values: for example, the reported metrics values may include the NMSE or SGCS measured at the output of the AI/ML CSI prediction model (e.g., using the current measured CSI as ground truth); values of measurements performed using evaluation CSI-RS; and/or CSI computed with the selected CSI reporting method.

The WTRU CSI prediction feedback may be reported in one or more reporting instances, where: a first report may include, e.g., the selected CSI reporting method, and/or the determined reason for CSI prediction performance degradation. The selected CSI reporting method and/or the determined reason for CSI prediction performance degradation may be represented as bitfields and/or indicated using UCI over the control channel (e.g., uplink (UL) control channel). The first report may be transmitted using UCI over the data channel (e.g., UL data channel).

A second report may include the CSI computed with the selected CSI reporting method, and/or values of measurements performed using evaluation CSI-RS (if requested by the NW). For example, the second report may be transmitted over the data channel (e.g., UL data channel).

A joint report may include both the selected CSI reporting method, the determined reason for CSI prediction performance degradation, and/or the computed CSI. For example, the joint report may be transmitted over the data channel (e.g., UL data channel).

The WTRU may report the model performance monitoring measurement values, for example as part of model life cycle management (LCM), as response to a NW request, and/or initiated by the WTRU when trigger conditions are met.

The WTRU may be configured for a periodic, an aperiodic, and/or a semi-persistent feedback report. The WTRU may perform aperiodic feedback report when it receives configuration for evaluation CSI-RS, and/or the NW requests measurement reports for the evaluation CSI-RS. The WTRU may use the configured periodic CSI feedback reports (e.g., Type 1 reports) to also indicate determined reason for CSI prediction performance degradation and/or the selected CSI reporting method.

A WTRU may perform artificial intelligence and/or machine learning (AI/ML) channel state information (CSI) prediction using temporally sparse CSI-reference signal (RS) configuration may send a request for evaluation CSI-RS within a monitoring window. The WTRU may then determine the reason for CSI prediction performance degradation. The WTRU may select the behavior and/or action as a function of determined reason for performance degradation.

A WTRU capable of AI/ML CSI prediction may receive a configuration for prediction and/or model monitoring. The configuration may include: a CSI-RS configuration and/or performance thresholds for prediction model monitoring. The WTRU may perform measurements for model performance monitoring. The measurements may include prediction error metrics such as normalized mean square error (NMSE) and/or squared generalized cosine similarity (SGCS). The measurements may include channel measurements such as Doppler, channel coherence time, and/or time domain channel property (TDCP).

The WTRU may evaluate trigger conditions. The trigger conditions may be satisfied when the measured prediction error meets the configured threshold. The trigger conditions may be satisfied when the measured channel has high Doppler (e.g., low coherence time). When the trigger conditions are met, the WTRU may send an indication to the network (NW). The indication may include a request for evaluation CSI-RS within a monitoring window, a report of the measurement value(s), and/or type(s) of measurements that met the trigger (e.g., channel coherence time and/or TDCP, etc.). The request for evaluation CSI-RS may include the number of evaluation CSI-RS in time domain. The monitoring window may be pre-defined, NW-configured, and/or the WTRU may send a request for specific window length.

The WTRU may select a CSI reporting method based on whether it receives evaluation CSI-RS within a monitoring window, and (if possible) measurements performed on the evaluation CSI-RS. If the WTRU does not receive evaluation CSI-RS within the monitoring window, then the WTRU may fall back to non-predictive CSI reporting and/or non-AI/ML predictive CSI reporting based on the model performance monitoring measurements. If the WTRU does receive evaluation CSI-RS within the monitoring window, then the WTRU may perform measurements on the evaluation CSI-RS. In addition to performing the measurement, the WTRU may determine to fallback to non-AI/ML predictive CSI reporting if the evaluation CSI-RS measurements indicate an AI/ML model issue. In addition to performing the measurement, the WTRU may determine to fallback to non-predictive CSI reporting for a configured time window if the interference measured on the evaluation CSI-RS is above a threshold. In addition to performing the measurement, the WTRU may determine to fall back to the closest historical CSI if the evaluation CSI-RS measurements indicate that the CSI-RS configuration is mismatched to the channel conditions (e.g., the channel decorrelates within the configured CSI-RS period). In addition to performing the measurement, the WTRU may determine to continue using the AI/ML model for AI/ML predictive CSI reporting when the WTRU receives configuration for aperiodic CSI-RS for prediction, e.g., if the evaluation CSI-RS measurements indicate that the CSI-RS configuration is mismatched to channel conditions (e.g., in time and/or frequency domain).

The WTRU may compute the CSI report using the selected CSI measurement report method. The WTRU may transmit one or more of: the computed CSI report, the selected CSI measurement report method, and/or the measurement used to select the CSI measurement report method.

What is claimed is:

1. A wireless transmit/receive unit (WTRU) comprising:
a processor and a memory, wherein the processor is configured to:
receive configuration information, wherein the configuration information comprises one or more performance thresholds for prediction model monitoring;
perform one or more measurements, wherein types of measurements to be performed comprise at least prediction error metrics and channel measurements;
determine that a triggering condition is satisfied when the one or more measurements meet the one or more performance thresholds;
send an indication comprising a request that evaluation channel state information (CSI)-reference signals (RSs) be transmitted within a monitoring window;
receive the evaluation CSI-RSs within the monitoring window;
select a CSI reporting method based on measurements associated with the evaluation CSI-RSs;
determine a CSI report based on the CSI reporting method; and
send one or more of the CSI report, the CSI reporting method, or a type of measurement used to select the evaluation CSI-RSs.

2. The WTRU of claim 1, wherein the processor is further configured to:
measure the evaluation CSI-RSs; and
determine, based on the measurements associated with the evaluation CSI-RSs, to fallback to a non-artificial intelligence or a machine learning (AI/ML) predictive CSI reporting when the measured evaluation CSI-RS measurements indicate an AI/ML model issue.

3. The WTRU of claim 1, wherein the processor is further configured to:
measure the evaluation CSI-RSs; and
determine, based on the measurements associated with the evaluation CSI-RSs, to fallback to non-predictive CSI reporting for a configured time window when an interference measured on the received evaluation CSI-RS is above a second threshold.

4. The WTRU of claim 1, wherein the processor is further configured to:
measure the evaluation CSI-RSs; and
determine, based on the measurements associated with the evaluation CSI-RSs, to fallback to a closest historical CSI when the evaluation CSI-RS measurements indicate that the configuration information is not applicable to the channel conditions.

5. The WTRU of claim 1, wherein the processor is further configured to:
perform an AI/ML model operation for AI/ML predictive CSI reporting when the WTRU configuration information further comprises an aperiodic CSI-RS for prediction.

6. The WTRU of claim 1, wherein the measurements associated with prediction error metrics comprise one or more of a normalized mean square error, (NMSE), a squared generalized cosine similarity (SGCS), or a mean absolute difference.

7. The WTRU of claim 1, wherein the measurements associated with channel measurements comprise one or more of a Doppler spread, a channel coherence time, or a time-domain channel property (TDCP).

8. The WTRU of claim 1, wherein the request for evaluation CSI-RS comprises an indication of a number of evaluation CSI-RSs in time domain.

9. The WTRU of claim 1, wherein the duration of the monitoring window is pre-configured by the WTRU, configured by a network, or requested by the WTRU and confirmed by the network.

10. The WTRU of claim 1, wherein the CSI report comprises one or more of a reason for CSI prediction performance degradation, the CSI reporting method, or values of the measurements that met the performance threshold.

11. A method implemented by a wireless transmit/receive unit (WTRU), the method comprising:
receiving configuration information, wherein the configuration information comprises one or more performance thresholds for prediction model monitoring;
performing one or more measurements, wherein types of measurements to be performed comprise at least prediction error metrics and channel measurements;
determining that a triggering condition is satisfied when the one or more measurements meet the one or more performance thresholds;
sending an indication comprising a request that evaluation channel state information (CSI)-reference signals (RSs) be transmitted within a monitoring window;
receiving the evaluation CSI-RSs within the monitoring window;
selecting a CSI reporting method based on measurements associated with the evaluation CSI-RSs;
determining a CSI report based on the CSI reporting method; and
sending one or more of the CSI report, the CSI reporting method, or a type of measurement used to select the evaluation CSI-RSs.

12. The method of claim 11, further comprising:
measuring the evaluation CSI-RSs; and
determining, based on the measurements associated with the evaluation CSI-RSs, to fallback to a non-artificial intelligence or a machine learning (AI/ML) predictive CSI reporting when the measured evaluation CSI-RS measurements indicate an AI/ML model issue.

13. The method of claim 11, further comprising:
measuring the evaluation CSI-RSs; and
determining, based on the measurements associated with the evaluation CSI-RSs, to fallback to non-predictive CSI reporting for a configured time window when an interference measured on the received evaluation CSI-RS is above a second threshold.

14. The method of claim 11, wherein the processor is further configured to:
measuring the evaluation CSI-RSs; and
determining, based on the measurements associated with the evaluation CSI-RSs, to fallback to a closest historical CSI when the evaluation CSI-RS measurements indicate that the configuration information is not applicable to the channel conditions.

15. The method of claim 11, further comprising to:
performing an AI/ML model operation for AI/ML predictive CSI reporting when the WTRU configuration information further comprises an aperiodic CSI-RS for prediction.

16. The method of claim 11, wherein the measurements associated with prediction error metrics comprise one or more of a normalized mean square error, (NMSE), a squared generalized cosine similarity (SGCS), or a mean absolute difference.

17. The method of claim 11, wherein the measurements associated with channel measurements comprise one or more of a Doppler spread, a channel coherence time, or a time-domain channel property (TDCP).

18. The method of claim 11, wherein the request for evaluation CSI-RS comprises an indication of a number of evaluation CSI-RSs in time domain.

19. The method of claim 11, wherein the duration of the monitoring window is pre-configured by the WTRU, configured by a network, or requested by the WTRU and confirmed by the network.

20. The method of claim 11, wherein the CSI report comprises one or more of a reason for CSI prediction performance degradation, the CSI reporting method, or values of the measurements that met the performance threshold.
